(19) United States
(12) Patent Application Publication
(10) Pub. No.: US 2007/0125424 A1
(43) Pub. Date: Jun. 7, 2007

(54) Flow-regulating valve of nozzle

(75) Inventor: Shun-Nan Luo, Taichung (TW)

Correspondence Address: KING - YUAN WANG, P.O. BOX 219, TAICHUNG CITY, TW

(73) Assignee: KING - YUAN WANG

(21) Appl. No.: 11/295,510

(22) Filed: Dec. 7, 2005

(51) Int. Cl. F17D 1/16

(52) U.S. Cl. 137/14

(57) ABSTRACT

An invention of a flow-regulating valve for a nozzle comprise a valve chamber with an inlet and outlet, a valve axle with a notch passage and a block section for regulating the flow of the fluid, and a regulative handle joined with the valve axle by a set of joining tray to drive the valve axle in the various angles. The above block section is set in the midsection of the valve axle and with an annular groove to clasp a annular block washer for blocking and shut off the flow of the fluid, and two annular washers set on two ends of the valve axle for avoiding the leakage from the gaps between the valve axle and the valve chamber. The defended fences are set on the inlet and the outlet of the valve chamber for avoiding the annular block washer to get off as the valve axle turning.

### FIELD OF THE INVENTION

The present invention relates to a fluid flow-regulating control device, and particularly to a flow-regulating valve of the nozzle.

### BACKGROUND OF THE INVENTION

Conventional nozzle control valve have been invented in various way to regulate the flow. As a simple way of controlling device, a ball valve has been used in the controlling water emission of the pistol nozzle in patent to Wang, U.S. Pat. No. 6,367,716. The above invention is attained by the water emission controlling structure which is formed of a shaft, an adjusting member, two locating members, and two washers. The shaft is provided with a spherical segment having a water emission hole. The shaft is actuated to displace by the adjusting member, thereby resulting in the amount of water is allowed to pass through the water emission hole of the shaft. There was another previous invention of the hose nozzle patented to Wang, U.S. Pat. No. 6,073,863, which control member is formed of a plug, a shaft, two washers, a water stopping piece, and a coiled spring. The plug is provided with an axial hole and an inclined bottom end. The plug is disposed in the top end of the water duct such that the plug presses against the lower end of the channel, and that the water duct is sealed off by the plug, and further that the axial hole of the plug is in communication with the water duct. In operation, the amount of water ejected is controlled by pushing up the actuating member so as to actuate the shaft to turn, thereby resulting in the water stopping piece to displace to open up the axial hole of the plug. As a result, the water is ejected in a desired amount from the water discharging tube via the water duct, the middle circular groove of the shaft, the axial hole of the plug, and the channel.

However, the first invention is according the ball valve to control the water emission, which couldn't fully stop and shut off the water to leak as the valve turned off.

The second previous invention sets a plug on a shaft to stop and seal the flow at switch off position, which causes the certain resistance of turning the shaft when the plug pushes against an outlet and the wall of the channel by the coiled spring.

According to the defects of the prior arts, therefore, the present invention achieves a simple sealing structure and the easy control of a flow-regulating valve for a nozzle.

### SUMMARY OF THE INVENTION

The present invention is invented to regulate the fluid flow with an effective sealing, easy assembling and control. An embodiment of the present invention, which is set in a pistol nozzle, comprises a valve axle, a regulative handle and a valve chamber for inserting the valve axle. The detail description of each part of the flow-regulating valve is as following:

The valve chamber, which is set in a pistol nozzle, comprises a channel chamber for inserting the valve axle, and with an inlet and an outlet both set a defended fence which can be model in cross or in parallel fence, for preventing a annular block washer to get off from the valve axle.

The valve axle comprises an axle with a notched passage set on the midsection for regulating the passing fluid by turning from various angles, two annular washers set on both end of the axle for sealing, and a block section set on the midsection of the axle with a annular block washer to stop and seal the flow when the block section is turned to block the inlet.

The regulative handle comprises a handle portion joined on the valve axle to drive for controlling the fluid flow, and a joining tray for clasping and joining the handle with the valve axle.

### BRIEF DESCRIPTION OF THE DRAWINGS

A preferred embodiment of the present invention is described below with reference to the accompanying drawings in which:

FIG. 1 an exploded view of the present invention;

FIG. 2 a assembled view of the present invention; and

FIG. 3 a cross sectional view of the valve chamber as shown in FIG. 1.

### DETAILED DESCRIPTION OF THE PREFERRED EMBODIMENT

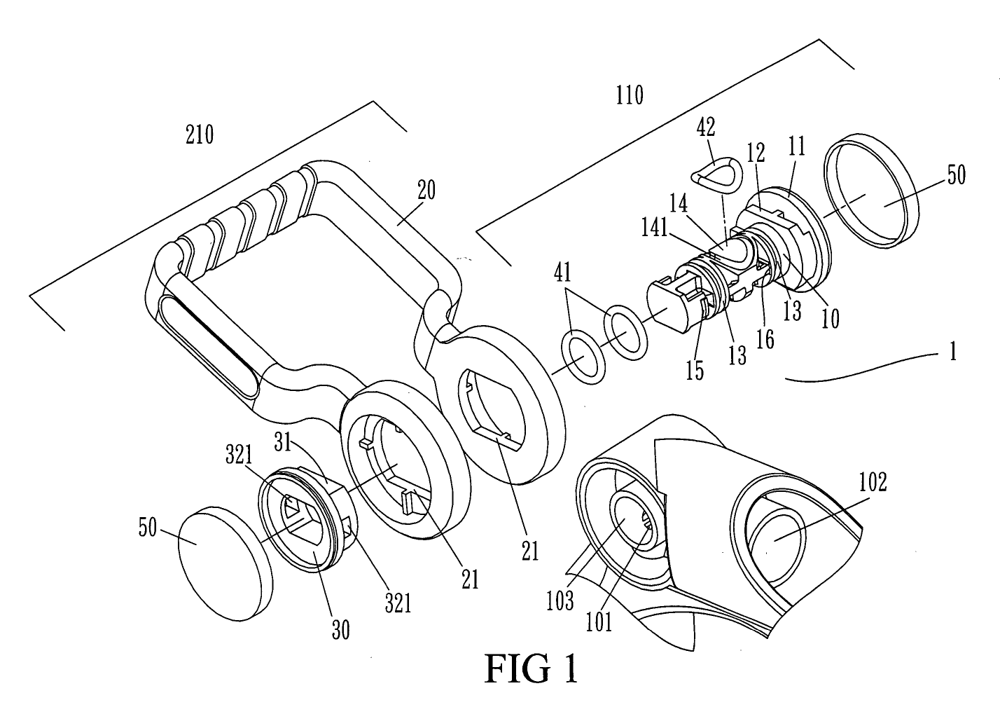

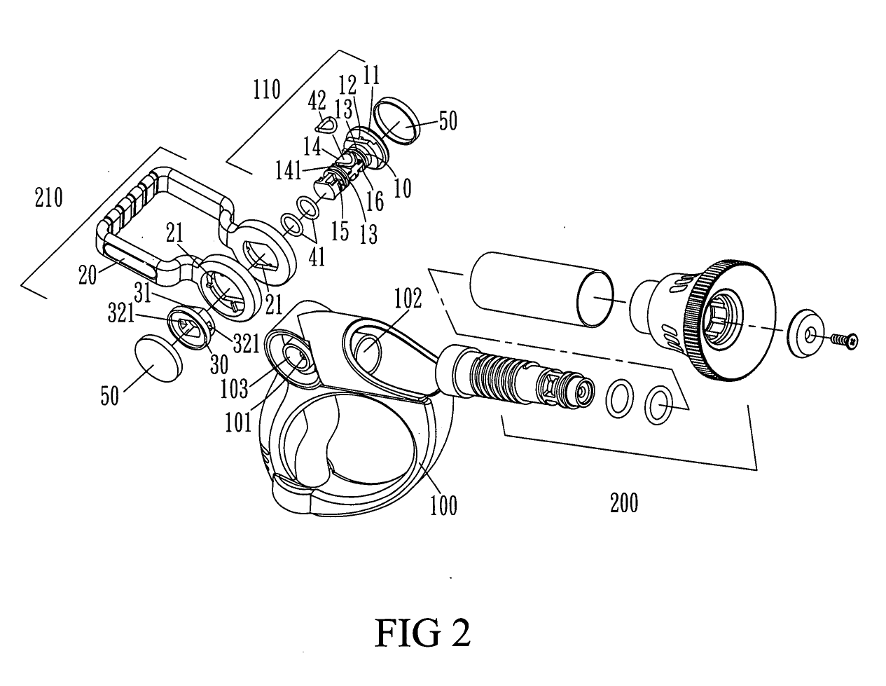

A preferred embodiment of a flow-regulating valve in the pistol nozzle according to the present invention is generally indicated in FIGS. 1 to 3.

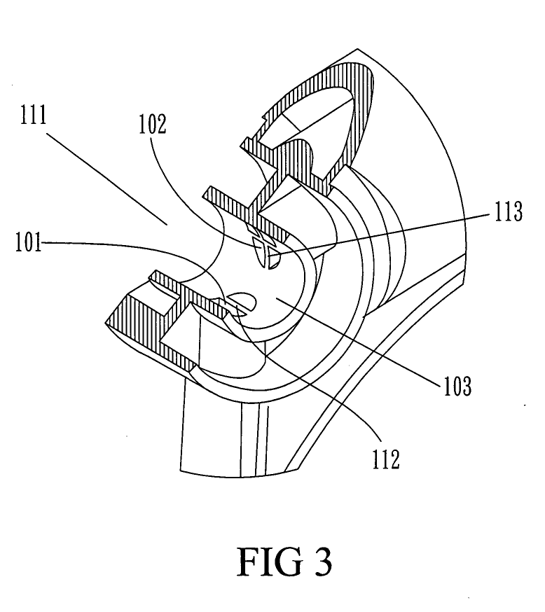

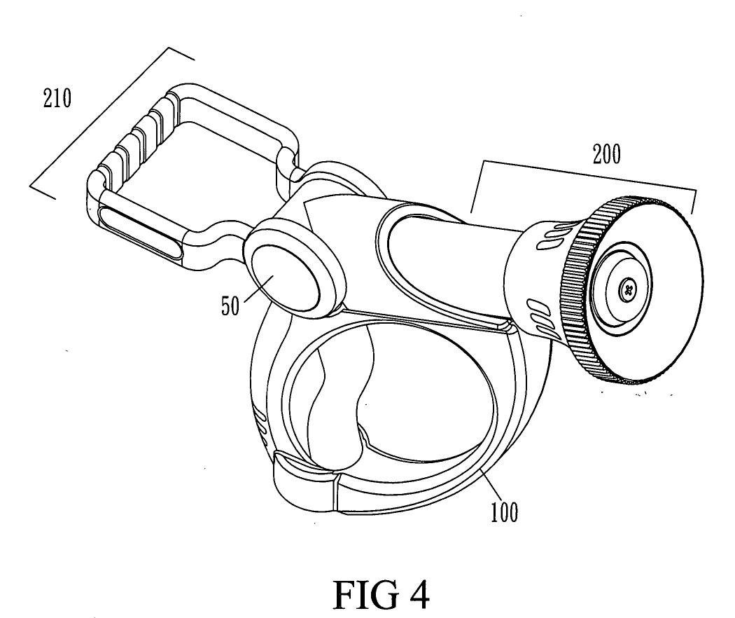

As shown in FIG. 1, the flow-regulating valve set in rear portion of a pistol nozzle 100 comprises a valve axle 110, a regulative handle 210, and a valve chamber 111 for inserting the valve axle 110. The detail description of each unit of the flow-regulating valve is as following: As shown in FIGS. 1 and 3, the valve chamber 111, which is set in rear part of a pistol nozzle 100, comprises a channel chamber 103, an inlet 101 on the bottom, and an outlet 102 connected to a sprinkle device 200. As shown in FIG. 3, two alternate embodiments of the defended fence set on the inlet 101 and the outlet 102, which are in parallel 112 and in cross 113, for preventing the annular block washer 42 to get off when the valve axle 110 is turning inside of the channel chamber 103.

The valve axle 110 comprise an axle 10 inserted into the channel chamber 103 with a notched passage 16 for water running through, two annular washers 41 set on two sideway grooves 13 for avoiding the leakage from the joining gaps between the axle 10 and the channel chamber 103, an left joining tray 11 set on left end for joining with left end of the regulative handle 210, and a block section 14 set on the midsection of the axle 10 with a annular groove 141 which retains a annular block washer 42 for sealing the inlet.

The regulative handle 210 comprise a handle 20 set two joining holes 21 on both ends for which joins with a block portion 12 of the left joining tray 11 and a block portion 31 of a tray 30, and the right joining tray 30 with a notch clasped by a raised buckle 15 on the right end of the valve axle 10 and the block portion 31. The joining trays 11,30 are closed with two covers 50. The block section 14 is drove in various angles by the regulative handle 210 to regulate the various flow which is depended on the blocked range of a gap of the inlet 101, and to stop and seal the water when the block section 14 fully blocked the inlet 101.

The embodiment of the present invention described above is to be regarded in all respects as being merely illustrative and not restrictive. Accordingly, the present invention may be embodied in other specific forms without deviating from the spirit thereof. The present invention is therefore to be limited only by the scope of the following appended claim.

What is claimed is:

1. A flow-regulating valve, the valve structure comprising;
a valve chamber set a channel chamber with an inlet and an outlet in the nozzle device,
a valve axle inserted and turning in the valve chamber comprising with a notched passage for fluid to pass through, a block section on the midsection for blocking an inlet, and two annular washers for preventing leakage from sideway joining gaps as the valve axle turning; and
a regulative handle joined on at least one end of the valve axle by a set of joining tray, for which drives the block section of the valve axle turning for various blocking gaps of the inlet to regulate the flow of the fluid.

2. The flow-regulating valve as in claim 1, wherein said block section of the valve axle comprises an annular block washer and an annular groove that clasps and limits the annular block washer.

3. The flow-regulating valve as in claim 1, wherein said inlet and the outlet are both set a defended fence for preventing the annular block washer to get off as turning the valve axle in the valve chamber.

4. The flow-regulating valve as in claim 1, wherein said joining tray comprises at least a joining notch for clasping with at least a raised buckle, which set on at least one end of the valve axle, and a block portion to wedge into one end of the regulative handle.
